(19) United States
(12) Patent Application Publication
(10) Pub. No.: US 2005/0022917 A1
(43) Pub. Date: Feb. 3, 2005

(54) Motorcycle radial tire

(76) Inventors: Christopher John Valentine, Coventry (GB); David Robert Watkins, Sutton Coldfield (GB)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/902,335

(22) Filed: Jul. 29, 2004

(30) Foreign Application Priority Data
Aug. 1, 2003 (GB) 0318049.4

(51) Int. Cl. B60C 9/00

(52) U.S. Cl. 152/538

(57) ABSTRACT

A motorcycle tire comprising a tread reinforced between its edges by a breaker assembly (4), a reinforcing carcass ply (11) of rubber covered cords radially inside the breaker assembly (4) and extending between two bead regions (7,8) and wrapped in each bead region (7,8) around an annular bead core (9,10) to form carcass ply turn-ups (11a,11b). The breaker assembly (4) includes a bandage ply (12) having a plurality of spaced apart strips (12a,12b,12c, etc) reinforced by cords oriented at substantially zero degrees to the centerline of the tire.

This invention relates to motorcycle tires and in particular but not exclusively to high performance race motorcycle tires.

Such tires utilize very wide treads which in transverse cross-section are sharply curved to provide good contact with the road surface when the motorcycle is steeply banked in cornering. Providing a consistent ground contact area or ‘tire footprint’ under all conditions is a major problem in determining general vehicle handling. Of particular importance in race motorcycle tires is the provision of high cornering power with the good stability to maximize cornering speeds under race conditions and the maintenance of tire shape and footprint under conditions of heavy braking, acceleration and cornering.

Motorcycle race tires have short sidewalls which extend to the tread edges radially and axially outwardly from the tire beads. The beads provide engagement to the wheel-rim on tapered bead seats. The sidewalls are reinforced by a carcass ply or plies which when tensioned by the inflation pressure act together with sidewall geometry to provide location of the curved tread regions to withstand cornering forces.

The sharply curved tread region of the tire is specially reinforced by a reinforcing breaker to give the required structural rigidity to allow for banking over of the motorcycle when cornering whilst giving sufficient flexibility to allow localized tread flattening in the ground contact patch for good road grip.

The breaker usually comprises two main breaker plies of rubber reinforced by closely spaced, parallel reinforcement cords of high modulus material such as aramid, steel or the like. These two plies are positioned such that the cords of each ply extend at an acute angle to one side of the centerline of the tread of the tire the cords of one ply being to the left and the other to the right.

To improve high speed performance it has become common in such tires to provide over the main breaker plies an additional cap or bandage ply in the form of a side by side winding of a single cord or a small number of cords in the form of a strip to provide a reinforcement layer which is a winding of cord substantially parallel to the circumferential centerline of the tire.

Similar bandaged breaker constructions are known in tires for cars. Car tires have breakers which are substantially flat axially of the tire and the zero degree bandage acts to restrict radial expansion at high speed. In car tires zero degree bandages have been disclosed which have changing spacing between adjacent windings to give additional bandage effect at the breaker edges in the tire shoulders. Also in Japanese patent number 61-15604 it has been suggested to form the bandage as a series of zero degree cord strips spaced apart across the breaker width. Such constructions, however, are intended to further reinforce car tire with substantially flat breakers to improve breaker integrity at high speed or to avoid breaker edge looseness.

In a high speed motorcycle tire it has been proposed to change the spacing of a single wound cord across the width of the tire tread. For example in EP 0 756 949 it is proposed to vary the cord spacing so as to provide a uniform tension state in the belt structure under the effect of the centrifugal force acting on the tire in working conditions.

However, there is a need not only to control centrifugal force but to provide in addition the ability to modify the contact patch to give different grip levels in the longitudinal and axial directions to give the necessary resultant consistent high levels of grip at different angles of lean of the motorcycle so that the rider can avail himself of maximized grip in conditions of braking and accelerating whilst banked over at different angles entering and leaving a corner.

It is the object of the present invention to provide a breaker which has such properties and thus to still further improve the stability and cornering power of high performance motorcycle tires when subjected to high braking and acceleration forces whilst cornering.

According to one aspect of the present invention a motorcycle tire comprises a tread reinforced between its edges by a breaker assembly, a reinforcing carcass ply of rubber covered cords radially inside the breaker assembly and extending between two bead regions and wrapped in each bead region around an annular bead core to form carcass ply turn-ups and between the tread edges and bead regions and tire sidewalls wherein the tread has in its normally inflated fitted condition a camber value C/L of between 0.5 and 0.7 and the breaker assembly includes a bandage radially outwards of the main breaker plies comprising a series of spaced apart strips each having a width W, a gap spacing G between adjacent strips and comprising a group of closely space parallel reinforcement cords laid at substantially zero degrees to the centerline of the tire.

By camber value is meant the ratio C/L between the radial distance C from the center to the edge of the tire tread and the axial distance L between the center and edge of the tread.

Preferably the spaced apart strips are formed by a single strip wound circumferentially around the tire at a winding pitch greater than the strip width to.

The winding pitch may be in the range of 1.5 times to 3.0 times the width of the strip and in a preferred embodiment the winding pitch is 2.0 times the width of the strip.

The width W of the strip is preferably in the range of 3 to 20 mm and in one a preferred construction the width is 15 mm.

Furthermore the strips can have differing widths W1, W2 etc. according to the stiffness required in each part of the tread. Also the gap spacing G can be varied between different pairs of adjacent strips. The gap spacings G1, G2, etc between adjacent strips may be determined from the average width of each pair of adjacent strips by the formula:
G=%(W1+W2)/2.

The reinforcement cords may be of any of the normal high modulus materials used in breakers including nylon, rayon, polyester, aramid, PEN (Polyethylene naphthalene 2,6 dicarboxylate, PET (polyethylene terephthalate, glass and steel.

Further aspects of the present invention will become apparent from the description of the following embodiments in conjunction with the attached diagrammatic drawing in which:

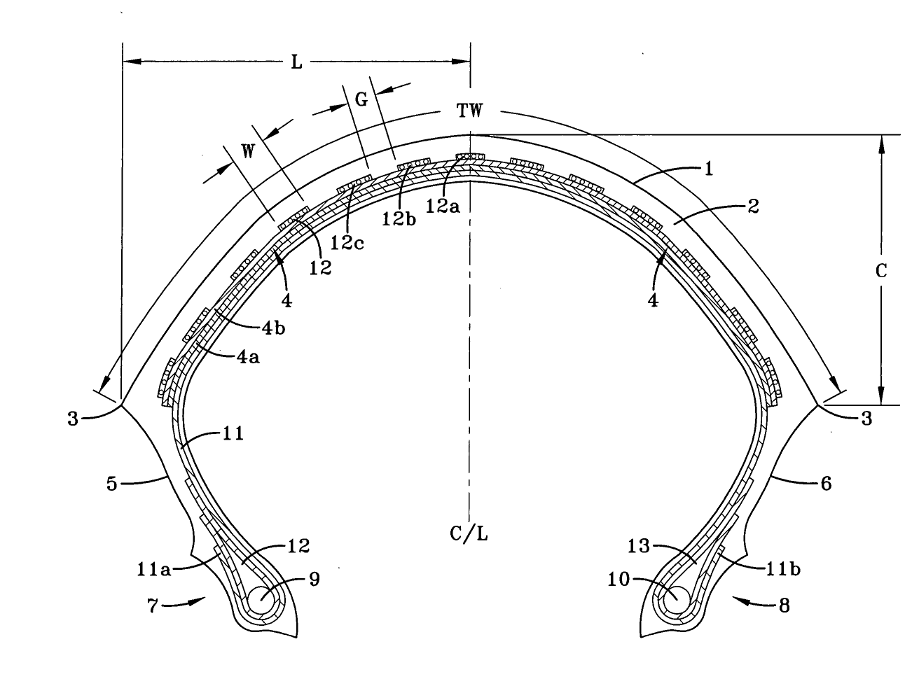

FIG. 1 shows in cross-section a motorcycle tire intended for high speed racing.

The tire of FIG. 1 is a 195/75R420 motorcycle race tire which has a camber value C/L of 0.6. It has a convex tread region 1 which is a plain none patterned tread 2 having tread edges 3. The tread region 1 is reinforced by a breaker assembly 4.

The tread region 1 is supported by a toroidal carcass which has a pair of sidewalls 5 and 6 terminating in bead regions 7 and 8. Each bead region is reinforced by an inextensible annular bead core 9 ad 10. Extending between each bead region 7 and 8 is a tire carcass reinforcement ply 11 which is anchored in each bead region by being turned around the respective bead core 7 and 8 laterally from the inside to the outside to form a ply turn-up 11a and 11b. The carcass reinforcement ply 11 comprises one ply of tire fabric comprising rubber covered nylon cords of 2/94 TEX laid with the cords at between 50° and 90° to the tire circumferential direction. Whilst the embodiment here comprises one carcass ply it may comprise multiple plies.

A hard rubber apex 12 is provided radially outwards of each bead core 9 between the main carcass ply 11 and each ply turn-up 11a and 11b.

The breaker assembly 4 comprises two breaker plies 4a and 4b which are rubber pies reinforced by parallel cords of Kevlar (Registered Trade Mark) aramid cord tire fabric each of 2/165 TEX. The cords in each of the breaker plies are oppositely inclined to each other at an angle of between 18°-30° and preferably 25° to the circumferential direction of the tire. The radially inner breaker ply 4a is narrower than the radially outer breaker ply 4b.

On top of the outer breaker ply 4b there is a bandage ply 12. In cross section of the tire as shown in FIG. 1 the bandage can be seen to comprise spaced apart strips 12a, 12b 12c etc. Each strip comprises fifteen adjacent cords of nylon tire reinforcement cord embedded in rubber the width W of the strips is 15 mm and they are spaced apart by a gap distance G which in this case is 15 mm although different widths and spacings may be used. In this tire the strips are made by winding a single strip of around the tire after the main breaker plies 4a and 4b have been fitted. The winding is begun at one side of the tire and continued at a pitch per tire revolution of 30 mm so as to give a gap spacing of 15 mm. Finally the tread strip 2 is fitted and the tire vulcanised in a tire press.

As an alternative to a single winding it is possible to construct the bandage by forming separate hoops of reinforcement strip at spaced apart positions around the tire. Alternatively each strip can be made by a single cord wound around the tire to form a strip and then moved in one turn a distance axially to give the gap space and then beginning to wind the next strip.

Furthermore the strips can have differing widths W1, W2 etc. according to the stiffness required in each part of the tread. Also the gap spacing G can be varied between different pairs of adjacent strips. The gap spacings G1, G2, etc between adjacent strips may be determined from the average width of each pair of adjacent strips by the formula:
G=%(W1+W2)/2.

Of course the width of strip chosen, the cord material and the spacing between adjacent strips is determined according to the desired final properties at each part of the tread of the tire.

The resulting tyre has a breaker which has properties effected by the spaced apart strips but most importantly the strips provide as well as the necessary resistance to high speed growth contributions to the longitudinal and axial bending stiffness of the tread strip in the small elemental regions which form the contact patch at any instant in a novel way. As a result the tyres have improved high speed performance combined with improved drive/braking force transmission in combination with high cornering power.

1. A motorcycle tire comprising a tread reinforced between its edges by a breaker assembly, a reinforcing carcass ply of rubber covered cords radially inside the breaker assembly and extending between two bead regions and wrapped in each bead region around an annular bead core to form carcass ply turn-ups and between the tread edges and bead regions and tire sidewalls wherein the tread has in its normally inflated fitted condition a camber value C/L of between 0.5 and 0.7 and the breaker assembly includes a bandage radially outwards of the main breaker plies comprising a series of spaced apart strips each having a width W, a gap spacing G between adjacent strips and comprising a group of closely space parallel reinforcement cords laid at substantially zero degrees to the centerline of the tire.

2. A motorcycle tire according to claim 1 characterized in that the spaced apart strips are formed by a single strip wound circumferentially around the tire at a winding pitch greater than the strip width W so as to space adjacent strips apart in cross section of the tire by gap spacings G.

3. A motorcycle tire according to claim 1 characterized in that the spaced apart strips comprise discrete circumferentially extending strips having widths W1, W2 . . . Wn and gap spacing between adjacent strips of G1, G2, Gn.

4. A motorcycle tire according to claim 3 characterized in that the widths of the strips W1, W″ Wn are all equal and the Gap spacings G1, G2, .Gn are all equal.

5. A motorcycle tire according to claim 3 characterized in that the widths of the strips W1, W2, Wn are different across the width of the tire.

6. A motorcycle tire according to claim 3 or 5 characterized in that the gap spacings G1, G2, Gn are different.

7. A motorcycle tire according to claim 6 characterized in that the gap spacings G1, G2, etc between adjacent strips are determined from the average width of adjacent strips by the formula
G=%(W1+W2)/2

8. A motorcycle tire according to claim 2 characterized in that the winding pitch is in the range of 1.5 times to 2.5 times the width W of the strip so that the gap spacing G between adjacent strips is in the range of 0.5 to 1.5 times the strip width W.

9. A motorcycle tire according to claim 2 characterized in that the winding pitch is 2.0 times the width W of the strip.

10. A motorcycle tire according to any of claims 1 to 9 characterized in that the strip has a width W in the range of 10 to 20 mm.

11. A motorcycle tire according to any of claims 1 to 10 characterized in that the width of the strip is 15 mm.

12. A motorcycle tire according to any of claims 1 to 1 1 characterized in that the reinforcement cords of the strip comprise nylon.
